(19) United States
(12) Patent Application Publication
(10) Pub. No.: US 2019/0323448 A1
(43) Pub. Date: Oct. 24, 2019

(54) CYLINDER LINER FOR INTERNAL COMBUSTION ENGINE AND METHOD FOR MAKING CYLINDER LINER

(71) Applicant: GM GLOBAL TECHNOLOGY OPERATIONS LLC, DETROIT, MI (US)

(72) Inventors: Jianghuai Yang, Rochester Hills, MI (US); Qigui Wang, ROCHESTER HILLS, MI (US); Benjamin E. Slattery, Tecumseh (CA); Melani R. Wright, Clarkston, MI (US); Huaxin Li, Rochester Hills, MI (US); Dale A. Gerard, BLOOMFIELD HILLS, MI (US); Daniel J. Wilson, Linden, MI (US)

(21) Appl. No.: 15/956,805

(22) Filed: Apr. 19, 2018

(51) Int. Cl. F02F 1/00; B22D 19/08; B22D 19/00; B22D 13/10

(52) U.S. Cl. CPC F02F 1/004; B22D 19/08; B22D 19/0009; F02F 2200/06; B22D 13/107; F02F 2001/008; B22D 13/101

(57) ABSTRACT

A method of manufacturing a cylinder liner for an engine block for a vehicle propulsion system and the cylinder liner made from the method. The method includes providing a cylinder liner mold having a cylindrical inner surface, masking a first portion of the cylindrical inner surface, applying a coating to a second portion of the cylindrical inner surface, and forming a cylinder liner by solidifying molten metal in the cylinder liner mold.

### FIELD

The present disclosure relates to a cylinder liner for an internal combustion engine and method for making a cylinder liner.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Cylinder liners for combustion engines made from, for example, cast iron, provide improved wear resistance in engine blocks that may be formed from lightweight materials, such as, for example, an aluminum alloy. These cylinder liners may be placed within an engine block mold and the engine block material may be cast around the cylinder liners. The cylinder liners are then embedded within and define the cylinder bores within the engine block. These liners are known as a “cast in place” type of liner.

It is important to maintain a strong bond between the liner and the block to prevent the liner from moving, to prevent or resist deformation during operation, and to improve thermal conductivity between the liner and the engine block. Cylinder liners which are known to provide an excellent mechanical and thermal bond include a rough exterior surface. These liner surfaces may be referred to as having an “as-cast,” “spiny,” or a rough cast surface. An example of such an “as-cast” surface may provide spines, mushrooms and crevices on the outside surface of the liner. Liners including exemplary “as-cast” surfaces may be provided by various manufacturers. One exemplary manufacturer, TPR Kabushiki Kaisha, holds a trademark registration for AsLock® for a cylinder liner under which they provide a liner having an as-cast external surface. Other manufacturers providing similar cylinder liners having a similar as-cast surface include Mahle, Federal Mogul and others.

Exemplary cylinder liners having an “as-cast” surface may include surface projections which extend between about 0.3 to 0.7 millimeters in depth on the external surface of the liner and are generally produced using a centrifugal casting process. In contrast, other types of liners are typically manufactured by machining a cast tube. This results in a smooth machined external surface, or a threaded or specifically patterned external surface such as, for example, a cross-hatched external surface, they are intended to be pressed into place in a previously cast engine block or may be “cast-in-place”.

Other types of interfaces between the cylinder liner and engine block have been developed such as, for example, an improved structural and thermal bond which is provided by machining special “dove-tail” shaped recessions in the inner surface of the engine block cylinder bore and then applying a cylinder liner material using a spray technique with, for example, a steel liner material. This type of interface provides an improved thermal bonding between the cylinder liner and the engine block.

A problem which has always been a challenge is the management of heat in the inter-bore section between adjacent cylinders in an engine block. There is only a very small mass of material in the engine block in the inter-bore section which is available to receive the heat being transferred into it from the combustion process occurring in the adjacent cylinders during operation of the engine. As the amount of heat in the engine block inter-bore section increases, the temperature of that material necessarily increases. This results in a potential degradation of material properties and characteristics of that engine block material. Indeed, at higher temperatures, an increase of only about 10 degrees Celsius may cause a reduction in properties of the engine block material by one half. For example, the engine block material may become soft and result in an undesirable amount of movement of the material away from the inter-bore section. This mechanism may be known as “recession” or “creep” in the industry. This movement or recession of the engine block material in the inter-bore section may result in a loss of seal between the engine block and a gasket seal and/or cylinder head. Indeed, the pressure of the cylinder head and gasket seal upon the deck surface of the engine block only tends to encourage movement of the engine block material away from the seal under the conditions where the increased temperature of the engine block material makes it increasingly susceptible to movement. This may result in an undesirable propagation of flame between adjacent cylinders and overall loss of efficiency in the combustion process.

Additionally, the movement or recession of engine block material may also induce stress into a cylinder liner and potentially alter the shape of a cylinder bore. The excellent structural bond between the as-cast cylinder liner and the engine block material means that when that engine block material recedes or moves, that moving material tends to induce a stress into the cylinder liner. In some instances, this heat related stress caused by the increased temperatures of the inter-bore engine block material may result in or encourage failure in the cylinder liner, such as by, for example, cracking of the cylinder liner and/or the engine block material.

The improved thermal conductivity provided by a cylinder liner with as-cast external features only exacerbates the above-described problems. The amount of heat being transferred into the engine block in the inter-bore section is increased because of the improved thermal transfer provided by the increased intimacy of the as-cast cylinder liner surface with the engine block material.

One attempt at addressing and managing the heat being transferred from the cylinders into the inter-bore section of the engine block is to provide a “saw-cut” in the deck surface across the inter-bore section such that a liquid coolant may flow through the area between cooling jackets arranged around the cylinders. However, providing the saw-cuts increases the cost, undesirably adds to the complexity of manufacture, increases the stress in the liner near the saw cut, and may lead to failure and/or cracking of the liner and the engine block material alongside the saw cut.

Another attempt to address these issues is to ensure that the cylinder liner may extend completely to the deck face, such that recession of the engine block material in the inter-bore section and loss of seal between the engine block and the cylinder head reduces the risk of combustion chamber seal and accompanying potential flame propagation between cylinders. This type of seal is typically achieved by pressing together of hard materials, including, for example, a multiple layer steel gasket. The hardness of these materials makes sealing somewhat difficult to achieve because the materials are not readily compliant such that they easily conform to each other under pressure. This pressure may yet further encourage recession of the block material away from the seal, which may be especially vulnerable because of the increased temperatures and resultant potential loss in material characteristics in the inter-bore areas.

Yet another attempt to address these problems has been to focus upon the composition of the alloy material that is used for the engine block. However, yet again, this may only increase the cost of the alloy, introduce complexity, and risk compromise of alloy characteristics that may be useful for other purposes.

### SUMMARY

In an exemplary aspect, a method of manufacturing a cylinder liner for an engine block for a vehicle propulsion system includes providing a cylinder liner mold having a cylindrical inner surface, masking a first portion of the cylindrical inner surface, applying a coating to a second portion of the cylindrical inner surface, and forming a cylinder liner by solidifying molten metal in the cylinder liner mold.

In this manner, a method for producing a cylinder liner reduces the post-casting steps, and improves the local heat transfer in non-inter-bore engine block regions, reduces residual stress from an engine block casting process incorporating the cylinder liner, reduces material costs by permitting a larger wall thickness, and improves structural bonding to the engine block.

In another exemplary aspect, the method further includes removing the masking from the first portion of the cylindrical inner surface prior to forming the cylinder liner.

In another exemplary aspect, the method further includes applying a second coating to the first portion of the cylindrical inner surface.

In another exemplary aspect, masking the first portion includes inserting a mask into the cylinder liner mold that masks the first portion of the cylindrical inner surface.

In another exemplary aspect, the method further includes inserting a spray tool having a spray nozzle into the cylinder liner mold prior to applying the coating.

In another exemplary aspect, the spray tool includes a mask that masks the first portion of the cylinder liner surface.

In another exemplary aspect, the cylinder liner mold further includes a spline formed in the second portion of the cylindrical inner surface.

In another exemplary aspect, a cylinder liner is produced by the method.

In another exemplary aspect, the cylinder liner includes a first engine block bonding surface formed adjacent to the first portion of the cylindrical inner surface and a second engine block bonding surface formed adjacent to the coating on the second portion of the cylindrical inner surface.

In another exemplary aspect, the second engine block bonding surface provides a lower heat transfer coefficient between the cylinder liner and an adjacent engine block material than the first engine block bonding surface.

In another exemplary aspect, the second engine block bonding surface extends a substantial portion of the axial length of the cylinder liner.

In another exemplary aspect, an outer diameter of the first engine block bonding surface is substantially equal to the outer diameter of the second engine block bonding surface.

In another exemplary aspect, an outer diameter of the first engine block bonding surface is less than the outer diameter of the second engine block bonding surface.

In another exemplary aspect, the cylinder liner includes a spline formed in the second engine block bonding surface.

In another exemplary aspect, the spline is a rectangular-shaped spline.

In another exemplary aspect, the spline is a triangular-shaped spline.

In another exemplary aspect, the spline is a dovetail-shaped spline.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is an isometric perspective view of an open deck engine block 100;

FIG. 2 is an isometric perspective providing a closer view of an inter-bore portion of the engine block 100 and illustrating a failure of liner and block material at the inter-bore area;

FIG. 3A illustrates a conventional cylinder liner with an as-cast spray or projection external surface;

FIG. 3B illustrates a cylinder liner having a first engine block bonding surface and a second engine block bonding surface in accordance with an exemplary embodiment of the present disclosure;

FIG. 4 illustrates an axial cross-sectional view of a centrifugal mold;

FIG. 5A is a perspective view of an exemplary spray tool in accordance with the present disclosure;

FIG. 5B illustrates another cross-section view of the mold of FIG. 4 viewed perpendicular to the axis of the mold;

FIG. 6 schematically illustrates a centrifugal casting process;

FIG. 7A illustrates a cross-sectional view of a cylinder liner in accordance with an exemplary embodiment of the present disclosure;

FIG. 7B is an enlarged view of a portion of the cylinder liner of FIG. 7A;

FIG. 8A illustrates a cross-sectional view of another exemplary centrifugal mold in accordance with the present disclosure;

FIG. 8B illustrates a cross-section view of another cylinder liner in accordance with an exemplary embodiment of the present disclosure;

FIG. 9A illustrates a cross-section view of yet another cylinder liner in accordance with an exemplary embodiment of the present disclosure;

FIG. 9B illustrates a close-up view of a portion of yet another cylinder liner in accordance with an exemplary embodiment of the present disclosure; and

FIG. 9C illustrates a close-up view of a portion of an additional cylinder liner in accordance with an exemplary embodiment of the present disclosure.

### DETAILED DESCRIPTION

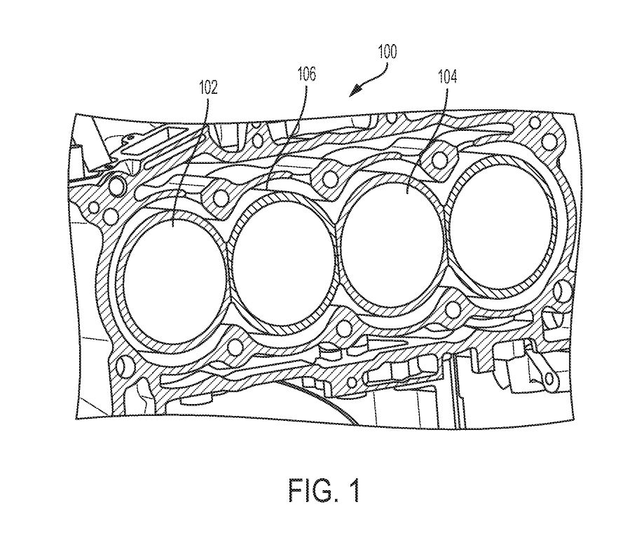

Referring now to the drawings, wherein the showings are for the purpose of illustrating certain exemplary embodiments only and not for the purpose of limiting the same, FIG. 1 illustrates an isometric perspective view of an open deck engine block 100. The engine block 100 includes a plurality of cylinder bores 102 that are defined by cylinder liners 104 which have been integrated into the engine block 100 during a casting process. In general, these cylinder liners 104 may be positioned into a mold and the molten engine block material, such as, for example, an aluminum alloy, may then be injected into the mold. The molten material then surrounds the cylinder liners as it fills the mold. The material cools to a solid and the liners are firmly bonded to the engine block material. In an exemplary process, the casting process may inject the molten engine block material under a high pressure to ensure intimate contact between the engine block material and the cylinder liner. As explained above, cylinder liners have been developed which include an “as-cast” exterior surface which provides an excellent structural and thermal bond between the liner and the engine block material.

The engine block 100 includes a cooling fluid jacket 106 which is exposed to (“open to”) the deck surface 110 and is, thus, known as an “open deck” block. The cooling fluid jacket 106 substantially surrounds the cylinder bores and provides fluid communication channels through which cooling fluid may be circulated to remove and manage heat which may be generated during a combustion process during operation of an engine incorporating the engine block 100.

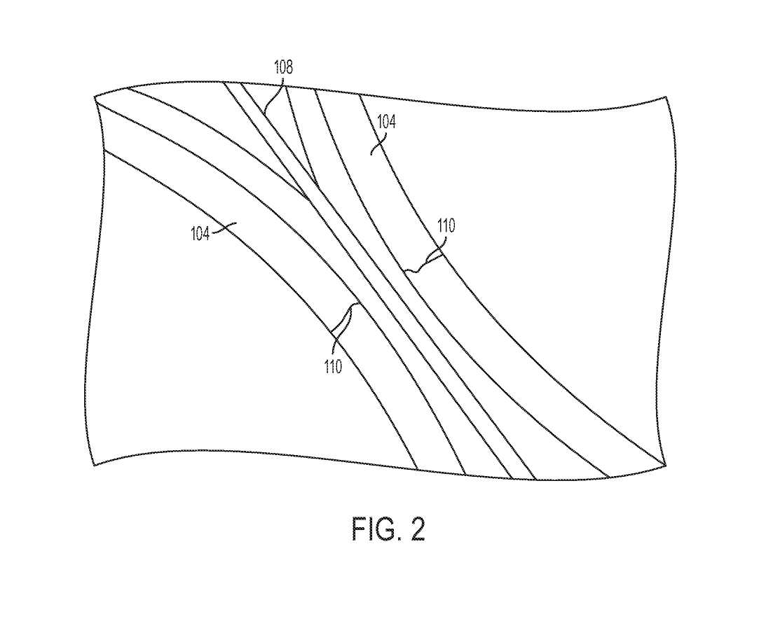

FIG. 2 is an isometric perspective providing a closer view of an inter-bore portion of the engine block 100 and illustrating a failure. The inter-bore is known as the portion of the engine block which is between cylinder bores. One method of improving the management and removal of heat from the cylinder bores is to provide a fluid communication channel 108 in the inter-bore section to enable a flow of fluid between cooling fluid jacket 106 sections adjacent to the inter-bore. These fluid communication channels 108 may generally be known as a “saw cut” channel and this description will refer to these channels 108 as a “saw cut” channel hereafter. While this description refers to a “saw cut” the method or tools used to create the slot in the inter-bore area of the engine block is not limited to any particular method or tool. FIG. 2 further illustrates a failure in which the cylinder liners 104 both have developed cracks 110. As explained above, these cracks 110 may have been caused by the increased temperatures of the inter-bore engine block material.

The present inventors understand that there is a substantial difference in the coefficients of thermal expansion between the cast-iron liner material and the aluminum alloy material and further appreciate that the “as-cast” surface of the liner provides a strong mechanical bond between the liner and the engine block material. The aluminum alloy has a larger coefficient of thermal expansion than that of cast-iron. This means that the aluminum alloy will tend to shrink more than the cast-iron material as it cools. This has not generally caused problems in engine blocks which included cast in place cylinder liners which do not have an “as-cast” surface because the aluminum alloy is not as firmly bonded to the cylinder liner. In those situations, the aluminum alloy is free to “slide” down the surface of cylinder liner which reduces or substantially eliminates the residual stress that may otherwise be placed on the liner from the engine block material. In stark contrast, upon the introduction of cylinder liners having “as-cast” surfaces, which provide a much stronger structural bond between the cylinder liner and the engine block, this has resulted in the engine block material introducing stress in the cylinder liner. Unlike the non-as-cast surface liners, the potential for residual stress could not be alleviated by the engine block material sliding down the outside of the liner during the cooling process. Thus, cylinder liners having an “as-cast” surface experience residual stresses which are not present in liners that do not have an “as-cast” surface such as the press-in-place liners which have machined smooth or threaded external surfaces.

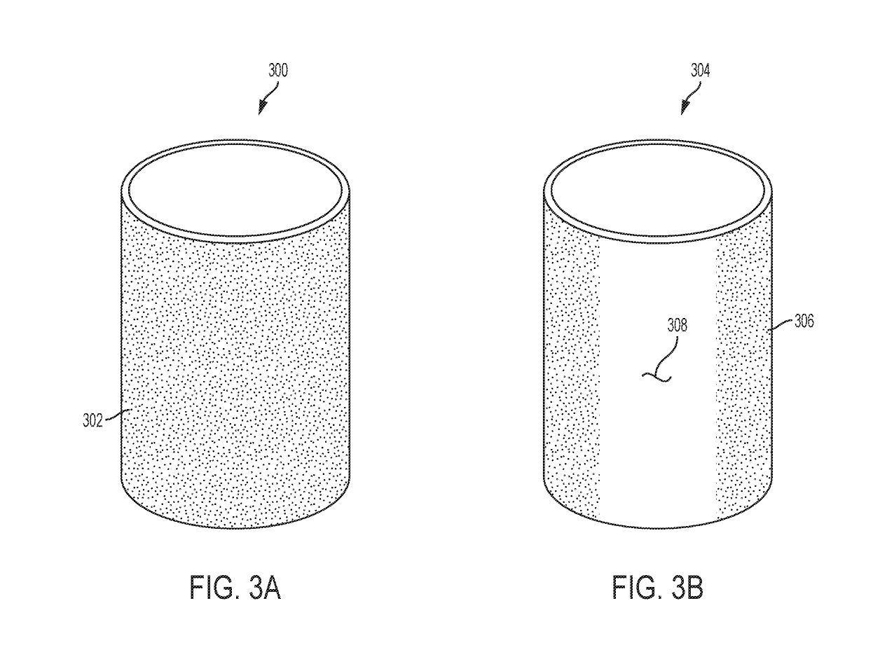

FIG. 3A illustrates a conventional cylinder liner 300 having an exterior surface 302 with an as-cast rough surface extending across substantially the entire exterior surface or outside diameter. In contrast, FIG. 3B illustrates an exemplary cylinder liner 304 having a first engine block bonding surface 306 and a second engine block bonding surface 308. The second engine block bonding surface 308 provides a lower heat transfer coefficient between the second engine block bonding surface 308 and an adjacent engine block material (not shown) into which the cylinder liner 304 may be cast than the heat transfer coefficient between the first engine block bonding surface 306 and an adjacent engine block material.

The second engine block bonding surface 308 extends a substantial portion of the axial length of the cylinder liner. It is to be understood that the second engine block bonding surface is not limited to any particular axial length. The extent of coverage of the second engine block bonding over the exterior surface of the cylinder liner only needs to be sufficient to reduce the thermal transfer coefficient from the cylinder bore into an inter-bore section of an engine block without limitation.

When the cylinder liner 304 is cast into an engine block, the second engine block bonding surface 308 may be oriented to be adjacent to an inter-bore section of the engine block such that the coefficient of thermal transfer between the cylinder liner 304 and the inter-bore section is less than the coefficient of thermal transfer between the cylinder liner 304 and other portions of the engine block. In this manner, the amount of heat transferred into the inter-bore section is reduced and the problems explained above, such as, for example, recession and cracking, are significantly reduced.

In the exemplary cylinder liner 304, the first engine block bonding surface 306 may extend around a substantial majority of the circumferential periphery of the cylinder liner 304. Further, in this exemplary cylinder liner 304, the first engine block bonding surface 306 is an as-cast rough surface while the second engine block bonding surface 308 may not have an as-cast rough surface.

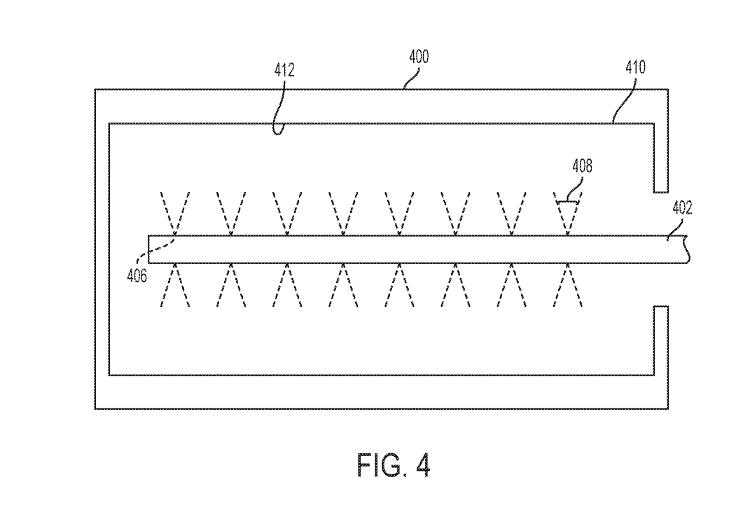

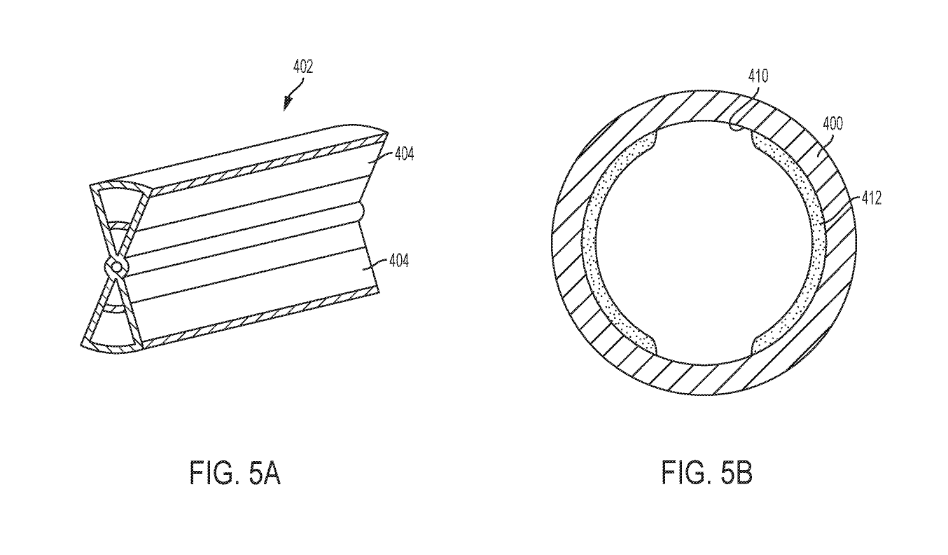

With reference to FIGS. 4 through 7B, an exemplary centrifugal casting method and tool for manufacturing a cylinder liner is described. FIG. 4 illustrates an axial cross-sectional view of a centrifugal mold 400. An inventive spray arm 402 is axially aligned with and positioned inside the mold 400. The spray arm 402 includes a plurality of nozzles 406 from which a slurry 408 may be sprayed onto the inner surface 410 of the mold 400 to form a first coating 412. The spray arm 402 also includes a set of masks 404 (see FIG. 5A) which block the application of the slurry 408 onto portions of the inner surface 410 of the mold 400. The masks 404 are not illustrated in FIG. 4 merely for the sake of simplicity. The composition of the slurry 408 may be selected such that it forms a textured surface on the cylinder liner during the casting of the cylinder liner, such as, for example, an as-cast rough surface. FIG. 5B illustrates another cross-section view of the mold 400 taken perpendicular to the axis of the mold 400. This view clearly illustrates that the use of the spray arm 402 having masks 404 results in the coating 412 only forming on those portions the inner surface 410 of the mold 400 which were not masked from the slurry spray 408 by the masks 404. Optionally, another coating (not shown) may also be applied to the inner surface 410 of the mold 400 such as, for example, a release coating which may facilitate the release of the cast cylinder liner from the mold 400. The present disclosure is not limited to any number of additional coatings, nor the composition of those coatings.

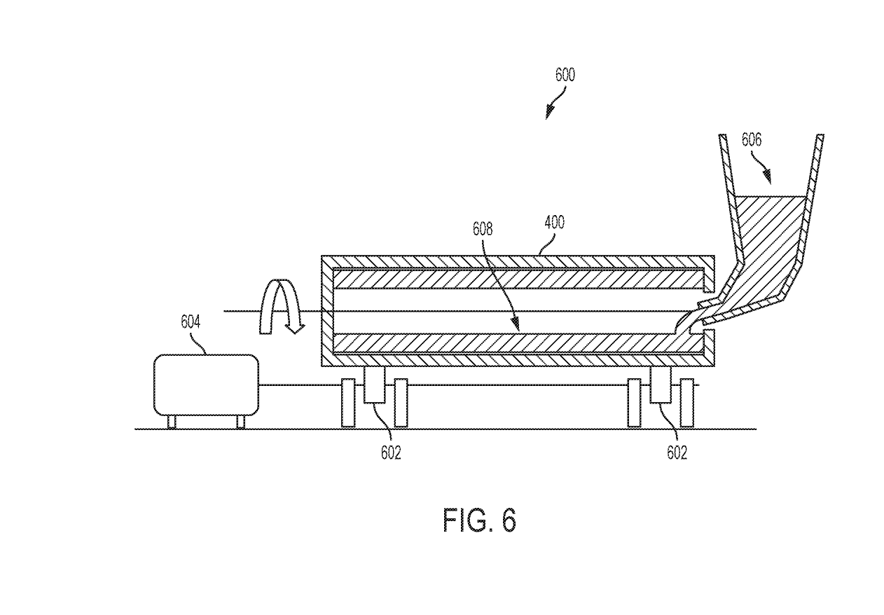

FIG. 6 illustrates the centrifugal casting process 600 following the application of the coating 412 onto portions of the inner surface 410 of the mold 400. The mold 400 may rest on rollers 602 may be rotated at high speed by a motor 604. Molten metal 606 may then be poured into the mold 400 and the centripetal forces may transfer the metal 606 evenly across the inner surface 410 and onto the coating 412 thereby forming a wall of a cylinder liner 608. The metal 606 solidifies while continuing to be rotated.

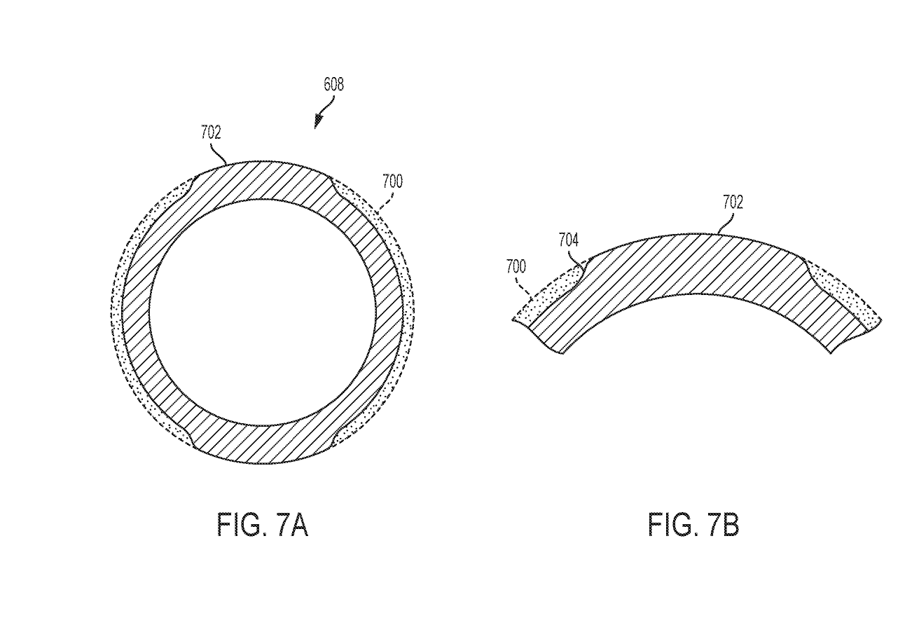

After solidification, the cylinder liner 608 has the structure illustrated in FIGS. 7A and 7B. As a result of the masks 404 blocking application of the slurry 408 during the spraying process (FIG. 4) onto portions of the inner surface 410 of the mold 410, only the portion 700 of the outer wall of the cylinder liner 608 that solidified in contact with the coating 412 form a textured surface 700, such as, for example, an as-cast rough surface. In contrast, that portion 702 of the outer wall of the cylinder liner 608 that solidified in the absence of the coating 412 formed a relatively smooth (substantially non-textured) surface 702. FIG. 7B illustrates an enlarged view of the smooth outer wall surface 702 and the transition 704 between the smooth surface 702 and the textured surface 700. As is clearly illustrated, the outer diameter of the smooth surface 702 is substantially the same as the outer diameter of the textured surface 700. This is in stark contrast to conventional textured cylinder liners which may have been machined to remove material from a portion of a textured surface to provide a smooth surface. In those machined liners, because machining necessarily removes material, the smooth surfaces of those liners have necessarily had outer diameters which were less than that of the textured surface. The present method and cylinder liner resulting from that method, maintains the wall thickness of the smooth surface which results in a stronger cylinder liner and the local stress as a result of engine operation will be reduced due to increased cross-section.

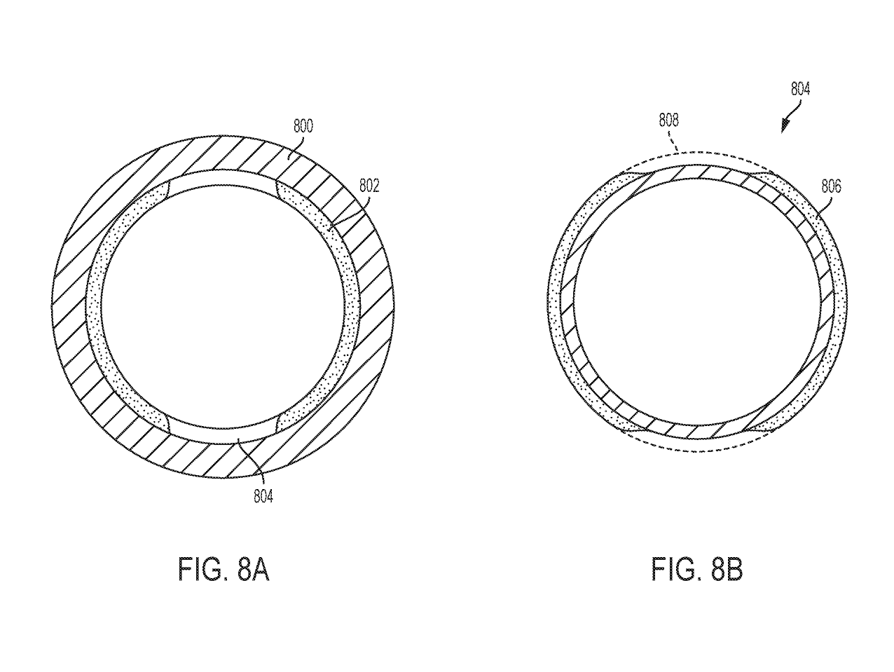

FIGS. 8A and 8B illustrate another exemplary method and resulting cylinder liner in accordance with the present disclosure. FIG. 8A illustrates a cross-sectional view of a centrifugal mold 800. The mold 800 includes a first coating 802 that has been applied by masking off areas of the inner surface of the mold such that only portions of the inner surface which were not masked are exposed to a slurry spray to form the first coating. In an exemplary step, the application of that first coating 802 may be applied with the spray arm 402 which includes masks 404 that are integrated into the spray arm 402. Alternatively, a separate masking tool may be used in combination with a spray arm (not shown). The present disclosure is not limited to any combination of spray elements and/or masking elements.

The mold 800 further includes a second coating 804 that may have been applied using a spray arm having complementary mask elements to that of the spray arm 402 of FIG. 5A. Alternatively, the second coating 804 may have been applied either after the application of the first coating 802, during the application of the first coating 802, or before the first coating 802, without limitation. Subsequent to the coating processes, the centrifugal mold 800 may be rapidly rotated and receive molten metal in a manner which was previously described with reference to FIG. 6. After solidification and removal from the mold 800, a cylinder liner 804 has a portion 806 of the outer surface that was solidified in contact with the first coating 802 which has a textured surface 806 and another portion 808 of the outer surface that was solidified in contact with the second coating 804 which has a relatively smooth surface 808. In contrast, to the cylinder liner 608 of FIG. 7A, the smooth surface 808 has an outer diameter which is less than the outer diameter of the textured surface 806. However, in contrast to conventional methods, the smooth surface 808 is provided to the cylinder liner 804 without requiring any machining. This greatly simplifies the manufacturing process and reduces the complexity.

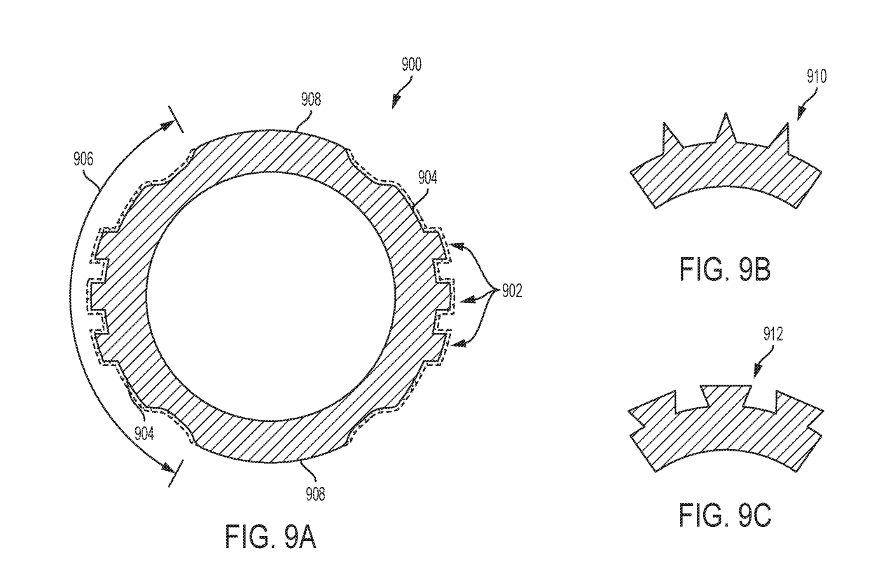

FIGS. 9A-9C illustrate additional exemplary embodiments of cylinder liners in accordance with the present disclosure. Cylinder liner 900 is produced in a manner similar to that explained with reference to FIGS. 4-7B, however, the cylinder liner 900 includes localized splines 902 on the outside surface of the liner. The cylinder liner 900 also includes textured surfaces 904 on each side of the liner 900 which encompass the circumferential extent 906 between the respective smooth surfaces 908. When the cylinder liner 900 having the localized splines 902 is cast into an engine block, the splines 902 operate to reduce bore ovality, reduce bore distortion, improve heat transfer, reduce wear and friction due to improved dimensional stability and reduce manufacturing cost and complexity when compared with other liner manufacturing processes. In an exemplary method, the splines 902 may be formed by providing mating female grooves on the interior surface of a liner mold (not shown).

FIGS. 9B and 9C illustrate exemplary alternative embodiments for the liner splines 902. FIG. 9B illustrates triangular shaped splines 910 and FIG. 9C illustrates dovetail-shaped splines 912. The splines may take any shape without limitation. The preferred segment of the liner circumference on which the splines are formed is the area substantially perpendicular to the bridge axial line (or inter-bore regions) where maximum cast ovality might otherwise occur.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method of manufacturing a cylinder liner for an engine block for a vehicle propulsion system, the method comprising:
providing a cylinder liner mold having a cylindrical inner surface;
masking a first portion of the cylindrical inner surface;
applying a coating to a second portion of the cylindrical inner surface; and
forming a cylinder liner by solidifying molten metal in the cylinder liner mold.

2. The method of claim 1, further comprising removing the masking from the first portion of the cylindrical inner surface prior to forming the cylinder liner.

3. The method of claim 2, further comprising applying a second coating to the first portion of the cylindrical inner surface.

4. The method of claim 1, wherein masking the first portion comprises inserting a mask into the cylinder liner mold that masks the first portion of the cylindrical inner surface.

5. The method of claim 1, further comprising inserting a spray tool having a spray nozzle into the cylinder liner mold prior to applying the coating.

6. The method of claim 5, wherein the spray tool comprises a mask that masks the first portion of the cylinder liner surface.

7. The method of claim 1, wherein the cylinder liner mold further comprises a spline formed in the second portion of the cylindrical inner surface.

8. A cylinder liner produced by the method of claim 1.

9. The cylinder liner of claim 8, wherein the cylinder liner comprises a first engine block bonding surface formed adjacent to the first portion of the cylindrical inner surface and a second engine block bonding surface formed adjacent to the coating on the second portion of the cylindrical inner surface.

10. The cylinder liner of claim 9, wherein the second engine block bonding surface provides a lower heat transfer coefficient between the cylinder liner and an adjacent engine block material than the first engine block bonding surface.

11. The cylinder liner of claim 9, wherein the second engine block bonding surface extends a substantial portion of the axial length of the cylinder liner.

12. The cylinder liner of claim 9, wherein an outer diameter of the first engine block bonding surface is substantially equal to the outer diameter of the second engine block bonding surface.

13. The cylinder liner of claim 9, wherein an outer diameter of the first engine block bonding surface is less than the outer diameter of the second engine block bonding surface.

14. The cylinder liner of claim 9, wherein the cylinder liner comprises a spline formed in the second engine block bonding surface.

15. The cylinder liner of claim 14, wherein the spline comprises a rectangular-shaped spline.

16. The cylinder liner of claim 14, wherein the spline comprises a triangular-shaped spline.

17. The cylinder liner of claim 14, wherein the spline comprises a dovetail-shaped spline.
